(19) United States
(12) Patent Application Publication
(10) Pub. No.: US 2019/0228677 A1
(43) Pub. Date: Jul. 25, 2019

(54) Potty Training System

(71) Applicant: Latonia Young, Plant City, FL (US)

(72) Inventor: Latonia Young, Plant City, FL (US)

(21) Appl. No.: 16/257,041

(22) Filed: Jan. 24, 2019

Related U.S. Application Data
(60) Provisional application No. 62/621,086, filed on Jan. 24, 2018.

(51) Int. Cl. G09B 19/00; A47K 11/04

(52) U.S. Cl. CPC G09B 19/0076; A47K 11/04

(57) ABSTRACT

An interactive potty training system that includes audio visual effects to help in the training of an infant.

### CROSS-REFERENCE TO RELATED APPLICATION

This application claims priority to U.S. Provisional Application No. 62/621,086 filed on Jan. 24, 2018, the disclosure of which, including any materials incorporated by reference therein, is incorporated herein by reference in its entirety.

### TECHNICAL FIELD

The present invention relates generally to portable toilet. More particularly, the present invention concerns a portable potty training system that is for use with toddlers.

### BACKGROUND

Potty training is a task that every child must go through as they grow from an infant into a young child. Potty training usually takes place at the younger ages of 1 to 2 years old. Most infants wear diapers initially after birth. Once the child is able to walk and understand instruction, potty training takes place in due course. Potty training can be quite frustrating for both the child and the parent and, as such, any training methods to assist in this process are typically well received. The object of the present invention is to provide an amusing and interactive potty training system for use by the child.

Attempts have been made, although unsuccessfully, to solve this problem. One illustrative attempt can be seen with respect to U.S. Pat. No. 5,369,820A, which generally discloses a toilet training potty. Although this disclosure does provide for a potty training seat with lighting, it fails to provide for an interactive and engaging potty training system.

As can be seen, various attempts have been made to solve the problems which may be found in the related art but have been unsuccessful. A need exists for a novel interactive potty training system to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a potty, toilet, seat, etc., are herein meant to include or encompass all equivalents for such elements. For example, in addition to a “potty”, any application element is also contemplated by the present invention. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention relates to a potty training system that overcomes the deficiencies of the prior art. The general purpose of the present invention, which shall be described subsequently in greater detail, is to allow a user to utilize an interactive potty training syesm for purposes of potty training a child.

The features of the invention which are believed to be novel are particularly pointed out and distinctly claimed in the concluding portion of the specification. By way of non-limiting example, the present invention provides a novel solution for potty training a young child. These and other features, aspects, and advantages of the present invention will become better understood with reference to the following drawings and detailed description.

The present invention provides an interactive potty training system that includes audio visual effects to help in the training of an infant. In some embodiments, the present invention provides for an ornamental design that is associated with the overall configuration for potty training. In a preferred embodiment of the present invention, the basin includes electronic controls, speakers, and visual effects to assist and encourage the infant or toddler.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows a first embodiment of a potty training system in accordance with an embodiment of the invention.

FIG. 2 shows a second embodiment of a potty training system in accordance with an embodiment of the invention.

### DETAILED DESCRIPTION

The present invention overcomes the limitations of the prior art by providing a new and more effective potty training system.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well known features, elements or techniques may not be shown in detail in order not to obscure the embodiments.

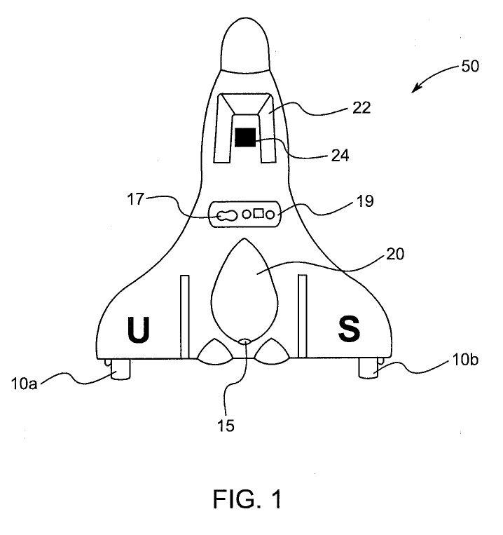

Turning attention to FIG. 1, a a first embodiment of the potty training system in accordance with an embodiment of the invention is shown. In the embodiment depicted, a viewer may perceive a basis 20 surrounded by an image that includes particular interactive functions related to the use of the basin 20. The basin 20 is a pot or commode used in potty training and as such its entire configuration is portable due to the wheels 10a, 10b. Further, the basin 20 can be emptied by a drain 16. A flush handle 17 is provided above the basis 20 along with a control panel 19. The control panel 19 can be used to configure functions relatd to other features of the present invention including the speaker 24 and the lighting 22 around the speaker 24. The use of the speaker 24 and lighting 22 provide audio and visual affirmations upon the successful use of the basin 20. The particular functions control the program by control vent 19 and through an interactive aspect of the potty training basin 20.

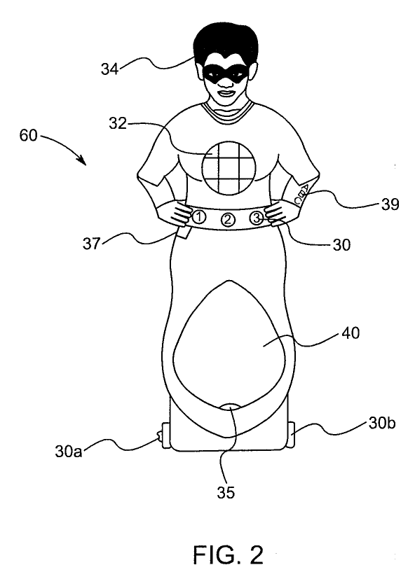

With respect to FIG. 2, an alternative embodiment of the potty training system 60 is whosn. In this potty training system 60, a basin 40 is shown at the lower portion of the drain system 60. In the embodiment depicted, a viewer may perceive wheels 30a, 30b are also provided with a drain 35 with the configuration in the form of a facial image 34. Lighting is provided on the chest area with a lighting arrangement 32. A flush handle 37 is shown at a beltline of the image and lighting system 30 is provided along the beltline. An additional lighting arrangement 39 is on one wrist of the image 34 The imaging and audio associated with this particular configuration also is controlled by the use of a control button used to encourage and teach the infant of potty train using the basin 40.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the potty training system generally described herein has been disclosed in connection with a number of embodiments shown and described in detail, various modifications should be readily apparent to those of skill in the art.

What is claimed is:

1. A portable potty training system, comprising:
a basin;
a drain for the basin;
wheels supporting the potty training unit;
a flush handle;
a lighting arrangement visible above the basin;
audio speakers; and
control buttons associated with the functions of the portable potty training system.
